(19) United States
(12) Patent Application Publication
(10) Pub. No.: US 2026/0089408 A1
(43) Pub. Date: Mar. 26, 2026

(54) IMAGING ELEMENT AND ELECTRONIC DEVICE

(71) Applicant: SONY SEMICONDUCTOR SOLUTIONS CORPORATION, Kanagawa (JP)

(72) Inventors: Yoshihide KOMATSU, Osaka (JP); Koshiro DATE, Osaka (JP); Hiroyasu TAGAMI, Osaka (JP)

(73) Assignee: SONY SEMICONDUCTOR SOLUTIONS CORPORATION, Kanagawa (JP)

(21) Appl. No.: 19/108,843

(22) PCT Filed: Jul. 25, 2023
(86) PCT No.: PCT/JP2023/027181

§ 371 Date: Mar. 5, 2025

(30) Foreign Application Priority Data
Sep. 16, 2022 (JP) 2022-147582

(51) Int. Cl. H04N 25/709; H04N 25/772; H04N 25/78

(52) U.S. Cl. CPC H04N 25/709; H04N 25/772; H04N 25/78

(57) ABSTRACT

To achieve lower power consumption of an imaging element mounted on an electronic device such as a smartphone. An imaging element of the present technology includes: an analog circuit unit including a pixel that performs photoelectric conversion; a logic circuit unit configured to process a signal read out from the pixel; a body potential generation unit configured to apply a body potential in a direction of lowering a threshold voltage to a well doped to enclose a transistor structure in a transistor forming the logic circuit unit; and a control unit configured to control the body potential for each operation mode designated from an outside.

### TECHNICAL FIELD

The present technology relates to an imaging element. Specifically, the present technology relates to an imaging element including: an analog circuit unit including a pixel that performs photoelectric conversion; and a logic circuit unit that processes a signal of the pixel, and an electronic device including the imaging element.

### BACKGROUND ART

An imaging element mounted on an electronic device such as a smartphone is required to improve a yield and reduce power consumption. Conventionally, as a technique for improving a yield, a power supply voltage variable technique (dynamic voltage and frequency scaling: DVFS) is known in which a variation in a process of an imaging element is monitored outside the imaging element, and a power supply voltage of the imaging element is externally controlled in accordance with the variation in the process (see, for example, Non-Patent Document 1).

### Citation List

### Non-Patent Document

Non-Patent Document 1: “A 45 nm Single-Chip Application-and-Baseband Processor Using an Intermittent Operation Technique” 2009 IEEE International Solid-State Circuits Conference

### SUMMARY OF THE INVENTION

### Problems to be Solved by the Invention

In the above-described conventional technology, in a case where there is a margin in a resulting state of a process of the imaging element, such as TT (PMOS: Typical, NMOS: Typical) and FF (PMOS: Fast, NMOS: Fast), control is performed to lower a power supply voltage of the imaging element, thereby reducing variations in the process and improving the yield. However, in the above-described conventional technology, although variations in the process can be reduced by external control of the power supply voltage of the imaging element, current consumption cannot be reduced, and reduction of power consumption is not considered.

The present technology has been made in view of such a situation, and an object thereof is to achieve lower power consumption of an imaging element.

### Solutions To Problems

The present technology has been made to solve the above-described problem, and a first aspect thereof is an imaging element including: an analog circuit unit including a pixel that performs photoelectric conversion; a logic circuit unit configured to process a signal read out from the above-described pixel; a body potential generation unit configured to apply a body potential in a direction of lowering a threshold voltage to a well doped to enclose a transistor structure in a transistor forming the above-described logic circuit unit; and a control unit configured to control the above-described body potential for each operation mode designated from an outside. As a result, an effect is provided that lower power consumption of the imaging element can be achieved. The “body potential” mentioned here is a potential applied to a well which is a region doped to enclose a transistor structure of a complementary metal oxide semiconductor (CMOS).

Furthermore, in the first aspect, when the above-described operation mode is a streaming operation mode, the above-described control unit may control the above-described body potential in accordance with each of a still image capturing mode and a moving image capturing mode. As a result, an effect is provided that gradation at some midpoint in a still image can be avoided, and it is possible to sequentially cope with a temperature fluctuation during 8K moving image capturing.

Furthermore, in the first aspect, when the above-described logic circuit unit is divided into a streaming function block and an always-on function block, the above-described control unit may apply, as the above-described body potential, a high potential higher than or equal to 0 V to an N-type well and a low potential lower than or equal to 0 V to a P-type well in the above-described streaming function block, as compared with the above-described always-on function block. As a result, an effect is provided that performance of the streaming function block can be improved by lowering the threshold voltage.

Furthermore, in the first aspect, the above-described body potential generation unit may apply a zero potential to a well doped to enclose a transistor structure in a transistor forming the above-described analog circuit unit. As a result, an effect is provided that the analog circuit unit can be subjected to normal ZBB potential control when the logic circuit unit is subjected to FBB potential control. Details of the FBB potential control and the ZBB potential control will be described later.

Furthermore, in the first aspect, the above-described body potential generation unit may apply a body potential in a direction of lowering a threshold voltage to a well doped to enclose a transistor structure in a transistor forming the above-described analog circuit unit. As a result, an effect is provided that, when the analog circuit unit is a vertical scanning unit or a comparator constituting an input stage of an analog-digital conversion circuit, there is an effect that a frame rate can be improved or power consumption can be reduced by an amount earned by increasing the speed.

Furthermore, in the first aspect, each of a transistor forming the above-described logic circuit unit and a transistor forming the above-described analog circuit unit is a MOS transistor having a fully depleted silicon-on-insulator structure. As a result, an effect is provided that it is possible to simultaneously achieve lower power consumption by the control of applying the body potential in the direction of lowering the threshold voltage and improvement of the yield by adaptive control.

Furthermore, a second aspect of the present technology is an imaging element including: an analog circuit unit including a pixel that performs photoelectric conversion; a logic circuit unit configured to process a signal read out from the above-described pixel; a body potential generation unit configured to apply a body potential in a direction of lowering a threshold voltage to a well doped to enclose a transistor structure in a transistor forming the above-described logic circuit unit. As a result, an effect is provided that lower power consumption of the imaging element can be achieved.

Furthermore, in the second aspect, the above-described body potential generation unit may control the above-described body potential by following a characteristic fluctuation factor of the imaging element. As a result, an effect is provided that variations in the entire imaging element can be absorbed.

Furthermore, in the second aspect, the above-described characteristic fluctuation factor may be at least one of a variation in a process, a variation in a junction temperature, or a variation in a power supply voltage. As a result, an effect is provided that variations in the entire imaging element can be absorbed.

Furthermore, in the second aspect, the above-described body potential generation unit may control the above-described body potential in accordance with at least one of a resulting state of a saturation electron count of the above-described pixel or a resulting state of conversion efficiency of the above-described pixel. As a result, an effect is provided that variations in the entire imaging element can be absorbed.

Furthermore, in the second aspect, the above-described body potential generation unit may apply a zero potential to a well doped to enclose a transistor structure in a transistor forming the above-described analog circuit unit. As a result, an effect is provided that the analog circuit unit can be subjected to normal ZBB potential control when the logic circuit unit is subjected to the FBB potential control.

Furthermore, in the second aspect, the above-described body potential generation unit may apply a body potential in a direction of lowering a threshold voltage to a well doped to enclose a transistor structure in a transistor forming the above-described analog circuit unit. As a result, an effect is provided that, when the analog circuit unit is a vertical scanning unit or a comparator constituting an input stage of an analog-digital conversion circuit, there is an effect that a frame rate can be improved or power consumption can be reduced by an amount earned by increasing the speed.

Furthermore, in the second aspect, each of a transistor forming the above-described logic circuit unit and a transistor forming the above-described analog circuit unit is a MOS transistor having a fully depleted silicon-on-insulator structure. As a result, an effect is provided that it is possible to simultaneously achieve lower power consumption by the control of applying the body potential in the direction of lowering the threshold voltage and improvement of the yield by adaptive control.

Furthermore, a third aspect of the present technology is an electronic device including: an imaging element; and an operation mode designation unit configured to designate an operation mode for the above-described imaging element, in which the above-described imaging element includes: an analog circuit unit including a pixel that performs photoelectric conversion; a logic circuit unit configured to process a signal read out from the above-described pixel; a body potential generation unit configured to apply a body potential in a direction of lowering a threshold voltage to a well doped to enclose a transistor structure in a transistor forming the above-described logic circuit unit; and a control unit configured to control the above-described body potential for each operation mode designated by the above-described operation mode designation unit. As a result, an effect is provided that lower power consumption of the imaging element mounted on the electronic device can be achieved.

### BRIEF DESCRIPTION OF DRAWINGS

FIG. 1 is a system configuration diagram illustrating a configuration example of an imaging element of the present technology.

FIG. 2 is a circuit diagram illustrating a circuit example of a pixel (pixel circuit) in the imaging element of the present technology.

FIG. 3 is a block diagram illustrating a basic configuration example of an analog-digital conversion unit in the imaging element of the present technology.

FIG. 4 is an external view illustrating an external configuration example of a smartphone which is an example of an electronic device according to the present technology.

FIG. 5 is a block diagram illustrating an internal configuration example of the smartphone which is an example of the electronic device according to the present technology.

FIG. 6 is a cross-sectional view illustrating a cross-sectional structure of a CMOS transistor, for explaining a CMOS transistor having a fully-depleted SOI structure in comparison with a bulk CMOS transistor.

FIG. 7 is a characteristic graph illustrating a relationship between power consumption and performance.

FIG. 8 is a circuit diagram illustrating a circuit example of an analog circuit unit.

FIG. 9 is a block diagram illustrating a configuration example of an imaging element according to a first embodiment of the present technology.

FIG. 10 is a table for explaining body potential control for each operation mode in the imaging element according to the first embodiment.

FIG. 11 is a state transition diagram illustrating state transition of the operation mode in the imaging element according to the first embodiment.

FIG. 12 is a block diagram illustrating a configuration example of an imaging element according to a second embodiment of the present technology.

FIG. 13 is an arrangement diagram illustrating an example of an arrangement image of an analog circuit unit, a logic circuit unit, a body potential generation unit, a PVT variation monitoring circuit, and an OTP in the imaging element according to the second embodiment.

FIG. 14 is a block diagram illustrating a configuration example of a characteristic fluctuation factor monitoring circuit in the imaging element according to the second embodiment.

FIG. 15 is a graph for explaining an image in a case of monitoring a resulting state of a process.

FIG. 16 is a graph for explaining a relationship between a minimum operating power supply voltage and a variation in a process.

FIG. 17 is a circuit diagram for explaining a saturation electron count Qs of a pixel and a conversion efficiency n of the pixel.

### MODE FOR CARRYING OUT THE INVENTION

Hereinafter, modes for carrying out the present technology (hereinafter, referred to as embodiments) will be described in detail with reference to the drawings. The present technology is not limited to the embodiments. In the following description, the same reference numerals are used for the same elements or elements having the same functions, and redundant description will be omitted. Note that the description will be given in the following order.
1. Imaging element of present technology
   1-1. Configuration example of imaging element
   1-2. Circuit example of pixel
   1-3. Configuration example of analog-digital conversion unit
2. Electronic device of present technology
   2-1. External configuration example of smartphone as example of electronic device
   2-2. Internal configuration example of smartphone as example of electronic device
   2-3. CMOS transistor having fully-depleted SOI structure
   2-4. Operations and effects of FBB potential control on analog circuit unit
3. First embodiment of present technology (example of controlling body potential for each operation mode of imaging element)
   3-1. Configuration example of imaging element according to first embodiment
   3-2. Body potential control for each operation mode
   3-3. Transition of operation mode
4. Second embodiment of present technology (example of controlling body potential by following characteristic fluctuation factor)
   4-1. Configuration example of imaging element according to second embodiment
   4-2. Arrangement image of individual circuit units constituting imaging element according to second embodiment
   4-3. Example of controlling body potential by following PVT variation
   4-4. Example of controlling body potential in accordance with variation in saturation electron count Qs and conversion efficiency η
5. Modifications
6. Configuration that can be adopted by present technology

### 1. Imaging Element of Present Technology

One example of an imaging element of the present technology is a complementary metal oxide semiconductor (CMOS) image sensor, which is a type of an X-Y address system imaging element. The CMOS image sensor is an imaging element fabricated by applying or partially using a CMOS process.

### 1-1. Configuration Example of Imaging Element

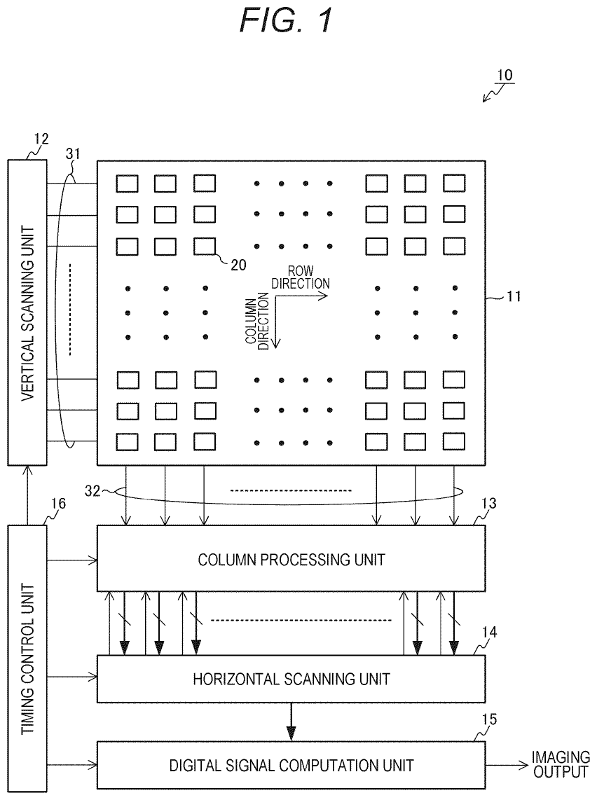

FIG. 1 is a block diagram illustrating a configuration example of an imaging element of the present technology. This imaging element 10 includes a pixel array unit 11 and a peripheral circuit unit of the pixel array unit 11. The peripheral circuit unit of the pixel array unit 11 includes, for example, a vertical scanning unit 12, a column processing unit 13, a horizontal scanning unit 14, a digital signal computation unit 15, a timing control unit 16, and the like.

The pixel array unit 11 has a configuration in which pixels (pixel circuits) 20 that perform photoelectric conversion are two-dimensionally arranged in a row direction and a column direction, that is, in a matrix. Here, the row direction refers to a direction in which the pixels 20 in a pixel row are arrayed, and the column direction refers to a direction in which the pixels 20 in a pixel column are arrayed. The pixel 20 performs photoelectric conversion to generate and accumulate photoelectric charges corresponding to an amount of incident light. In the example illustrated in FIG. 1, the pixel array of the pixel array unit 11 is a pixel array of m rows and n columns (m and n are integers). That is, “m” represents the number of rows, and “n”represents the number of columns.

In the pixel array unit 11, a pixel control line 31 is wired for every pixel row, for the pixel array of m rows and n columns. Furthermore, a signal line 32 is wired for every pixel 20.

When reading a signal from the pixel 20, the pixel control line 31 transmits a drive signal output from the vertical scanning unit 12 in units of pixel rows. In FIG. 1, the pixel control line 31 is illustrated as one wiring line, but the number thereof is not limited to one. One end of the pixel control line 31 is connected to an output terminal corresponding to each row of the vertical scanning unit 12. The signal line 32 transmits a signal read out from the pixel 20 to the column processing unit 13.

Hereinafter, each component of the peripheral circuit unit of the pixel array unit 11, that is, the vertical scanning unit 12, the column processing unit 13, the horizontal scanning unit 14, the digital signal computation unit 15, and the timing control unit 16 will be described.

The vertical scanning unit 12 includes a shift register, an address decoder, and the like, and controls scanning of a pixel row and an address of the pixel row on the basis of a timing control signal supplied from the timing control unit 16 at a time of selecting each pixel 20 of the pixel array unit 11. Although a specific configuration of the vertical scanning unit 12 is not illustrated, the vertical scanning unit 12 generally includes two scanning systems of a reading scanning system and a sweeping scanning system.

The column processing unit 13 reads a signal from each pixel 20 of the pixel array unit 11 on the basis of a timing control signal supplied from the timing control unit 16, performs analog-digital conversion processing, correlated double sampling processing (CDS processing), and the like, and outputs the signal as a pixel signal. Details of an analog-digital conversion unit which is one of functional units of the column processing unit 13 will be described later.

The horizontal scanning unit 14 includes a shift register, an address decoder, and the like, and selectively scans each pixel 20 of the pixel array unit 11 sequentially on the basis of a timing control signal supplied from the timing control unit 16. By the selective scanning with the horizontal scanning unit 14, pixel signals converted into digital signals for every unit circuit in the column processing unit 13 are sequentially output to the digital signal computation unit 15.

The digital signal computation unit 15 performs predetermined digital computation on the pixel signals sequentially output from the horizontal scanning unit 14 on the basis of a timing control signal supplied from the timing control unit 16, and sets a computation result as an imaging output.

The timing control unit 16 generates various timing signals, clock signals, control signals, and the like on the basis of a synchronization signal provided from an outside. Then, the timing control unit 16 performs drive control of the vertical scanning unit 12, the column processing unit 13, the horizontal scanning unit 14, the digital signal computation unit 15, and the like on the basis of the generated signals.

### 1-2. Circuit Example of Pixel

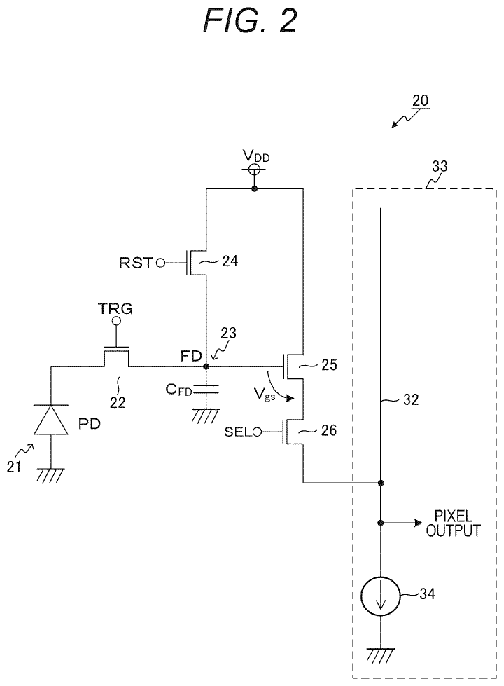

FIG. 2 is a circuit diagram illustrating a circuit example of the pixel (pixel circuit) 20 in the imaging element 10 of the present technology. Each pixel 20 of the pixel array unit 11 includes a photoelectric conversion unit 21, a charge transfer unit 22, a charge-voltage conversion unit 23, a charge resetting unit 24, a signal amplification unit 25, and a pixel selection unit 26. A predetermined voltage is supplied from a power supply (pixel power supply) of the pixel 20 to the charge resetting unit 24 and the signal amplification unit 25.

Here, as the charge transfer unit 22, the charge resetting unit 24, the signal amplification unit 25, and the pixel selection unit 26, for example, an N-type MOS field effect transistor (hereinafter, referred to as a MOS transistor) can be used. However, a combination of conductivity types of the four MOS transistors 22, 24, 25, and 26 exemplified here is merely an example, and the combination is not limited thereto.

For the pixel 20, as the pixel control line 31 described above, a plurality of pixel control lines is wired in common to the respective pixels 20 of the same pixel row. The plurality of pixel control lines is connected to an output end corresponding to each pixel row of the vertical scanning unit 12, in units of pixel rows. The vertical scanning unit 12 appropriately outputs a transfer signal TRG, a reset signal RST, and a selection signal SEL to the plurality of pixel control lines.

Note that a load MOS circuit 33 is connected to one end of the signal line 32 wired for every pixel column of the pixel array unit 11. The load MOS circuit 33 includes a constant current source 34 including a MOS transistor.

The photoelectric conversion units 21 are PN-junction photodiodes (PDs). The photodiode has an anode electrode connected to a low potential side power supply (for example, ground), and generates and accumulates charges according to an amount of incident light.

The charge transfer unit 22 transfers the charges accumulated in the photoelectric conversion unit 21 to the charge-voltage conversion unit 23, in accordance with the transfer signal TRG provided from the vertical scanning unit 12. Specifically, the transfer signal TRG that is active at a high level is supplied from the vertical scanning unit 12 to a gate electrode of a transistor constituting the charge transfer unit 22. Then, the transistor constituting the charge transfer unit 22 is brought into a conductive state, and transfers the charges accumulated in the photoelectric conversion unit 21 to the charge-voltage conversion unit 23.

The charge-voltage conversion unit 23 is a capacitance CFD of a floating diffusion (FD) region formed between a drain region of the transistor constituting the charge transfer unit 22 and a source region of a transistor constituting the charge resetting unit 24. The charge-voltage conversion unit 23 converts the charges transferred from the photoelectric conversion unit 21 by the charge transfer unit 22 into a voltage.

The charge resetting unit 24 resets the charges accumulated in the charge-voltage conversion unit 23 in accordance with the reset signal RST provided from the vertical scanning unit 12. Specifically, the transistor constituting the charge resetting unit 24 is connected between a node of a power supply voltage V_{DD} and the charge-voltage conversion unit 23, and the reset signal RST that is active at a high level is provided from the vertical scanning unit 12 to a gate electrode of the transistor. Then, the transistor constituting the charge resetting unit 24 is brought into a conductive state when the reset signal RST becomes a high level, and resets the charges accumulated in the charge-voltage conversion unit 23.

The signal amplification unit 25 amplifies the voltage converted by the charge-voltage conversion unit 23, and outputs a pixel signal at a level corresponding to the charges accumulated in the charge-voltage conversion unit 23. A gate electrode of a transistor constituting the signal amplification unit 25 is connected to the charge-voltage conversion unit 23, and a drain electrode is connected to the node of the power supply voltage V_{DD}. Then, the transistor constituting the signal amplification unit 25 serves as an input unit of a readout circuit that reads out charges obtained by photoelectric conversion in the photoelectric conversion unit 21, that is, a source follower circuit. That is, in the transistor constituting the signal amplification unit 25, a source electrode is connected to the signal line 32 via the pixel selection unit 26, thereby constituting the source follower circuit with the constant current source 34 connected to one end of the signal line 32.

The pixel selection unit 26 selects any pixel 20 in the pixel array unit 11 under selective scanning by the vertical scanning unit 12. A transistor constituting the pixel selection unit 26 is connected between the source electrode of the transistor constituting the signal amplification unit 25 and the signal line 32, and the selection signal SEL that is active at a high level is supplied from the vertical scanning unit 12 to a gate electrode of the transistor. Then, when the selection signal SEL becomes a high level, the transistor constituting the pixel selection unit 26 is brought into a conductive state. As a result, the pixel 20 enters a selected state. When the pixel 20 is brought into the selected state, a signal output from the signal amplification unit 25 is read out to the column processing unit 13 via the signal line 32.

The pixel 20 of the circuit configuration example described above sequentially outputs a reset signal (so-called P-phase signal), which is a reset level at a time of resetting the charge-voltage conversion unit 23 with the charge resetting unit 24, and a data signal (so-called D-phase signal), which is a signal level corresponding to a charge based on the photoelectric conversion in the photoelectric conversion unit 21. That is, the pixel signal output from the pixel 20 includes the reset signal at the time of resetting and the data signal at the time of photoelectric conversion in the photoelectric conversion unit 21.

### 1-3. Basic Configuration Example of Analog-Digital Conversion Unit

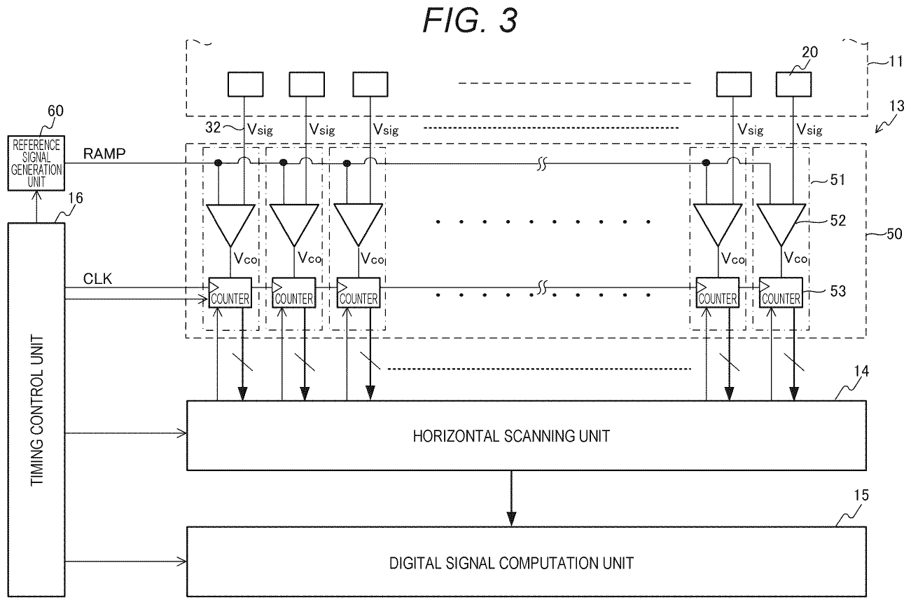

Next, a basic configuration example of an analog-digital conversion unit which is one of the functional units of the column processing unit 13 will be described. FIG. 3 is a block diagram illustrating a basic configuration example of the analog-digital conversion unit in the imaging element 10 of the present technology. FIG. 3 also illustrates a peripheral circuit unit of the analog-digital conversion unit.

An analog-digital conversion unit 50, which is one of the functional units of the column processing unit 13, acquires an analog pixel signal Vsig supplied from each pixel 20 of the pixel array unit 11 through the signal line 32 on the basis of a timing control signal supplied from the timing control unit 16, and sequentially converts the pixel signal Vsig into a digital pixel signal.

The analog-digital conversion unit 50 includes a plurality of analog-digital conversion circuits 51 provided corresponding to the individual pixels 20 of the pixel array unit 11. In the imaging element 10 according to an embodiment of the present technology, for example, a so-called single-slope analog-digital conversion circuit, which is an example of a reference signal comparison analog-digital conversion circuit, is used as the analog-digital conversion circuit 51.

In the analog-digital conversion unit 50 using the single-slope analog-digital conversion circuit, a reference signal of an inclined waveform that linearly changes with time with a predetermined inclination (for example, monotonically decreasing), that is, a reference signal RAMP of a ramp wave is used as a reference signal at a time of analog-digital conversion. The reference signal RAMP of the ramp wave is generated in a reference signal generation unit 60 on the basis of a timing control signal supplied from the timing control unit 16. The reference signal generation unit 60 can be configured using, for example, a digital-analog conversion circuit.

The analog-digital conversion circuit 51 includes a comparator 52 and a column counter 53, and is provided for each pixel 20 of the pixel array unit 11.

The comparator 52 uses, as a comparison input, the analog pixel signal Vsig supplied from each pixel 20 of the pixel array unit 11 through the signal line 32, and uses, as a reference input, the reference signal RAMP of the ramp wave generated by the reference signal generation unit 60, to compare both signals. Then, for example, at a timing when the reference signal RAMP of the ramp wave exceeds a voltage value of the analog pixel signal Vsig, a signal notifying the fact is output as a comparison result Vco. As a result, the comparator 52 outputs, as the comparison result Vco, a pulse signal having a pulse width corresponding to a signal level of the analog pixel signal Vsig, specifically, a pulse signal having a pulse width corresponding to magnitude of the signal level.

A clock signal CLK is supplied from the timing control unit 16 to the column counter 53 at the same timing as a supply start timing of the reference signal RAMP of the ramp wave to the comparator 52. The column counter 53 performs a counting operation in synchronization with the clock signal CLK, thereby measuring a period of a pulse width of an output pulse of the comparator 52, that is, a period from a start of the comparison operation to an end of the comparison operation. A count result (count value) of the column counter 53 is supplied to the horizontal scanning unit 14 as a digital value obtained by digitizing the analog pixel signal Vsig.

As described above, the analog-digital conversion unit 50 including the single-slope analog-digital conversion circuit 51 compares the analog pixel signal Vsig output from the pixel 20 with the reference signal RAMP of the ramp wave generated by the reference signal generation unit 60. Then, a digital value can be obtained from time information from the start of the comparison to a timing at which a magnitude relationship between the analog pixel signal Vsig and the reference signal RAMP of the ramp wave changes (that is, a timing at which an output of the comparator 52 is inverted).

### 2. Electronic Device of Present Technology

The imaging element 10 of the present technology described above can be used as an imaging element mounted on various electronic devices. Examples of the electronic device on which the imaging element is mounted include mobile devices such as a smartphone, a digital camera, a tablet, and a personal computer. However, the present technology is not limited to the mobile device. Here, a smartphone is exemplified as a specific example of an electronic device (that is, an electronic device of the present technology) on which the imaging element 10 of the present technology can be mounted.

### 2-1. External Configuration Example of Smartphone

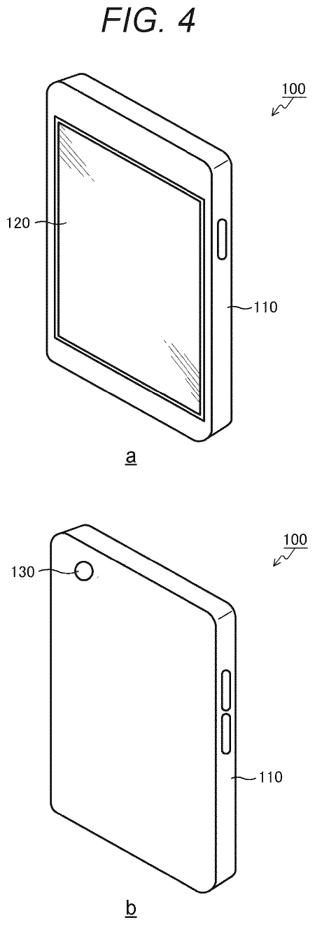

FIG. 4 is an external view illustrating an external configuration example of a smartphone which is an example of the electronic device according to the present technology. In, FIG. 4 “a” is an external view of the smartphone as viewed from a front side, and “b” of FIG. 4 is an external view of the smartphone as viewed from a back side.

A smartphone 100 according to the present example includes a display unit 120 on a front side of a housing 110. Furthermore, the smartphone 100 includes, for example, an imaging unit 130 in an upper portion on a back surface side of the housing 110. Then, the imaging element 10 of the present technology can be used as the imaging unit 130.

### 2-2. Internal Configuration Example of Smartphone

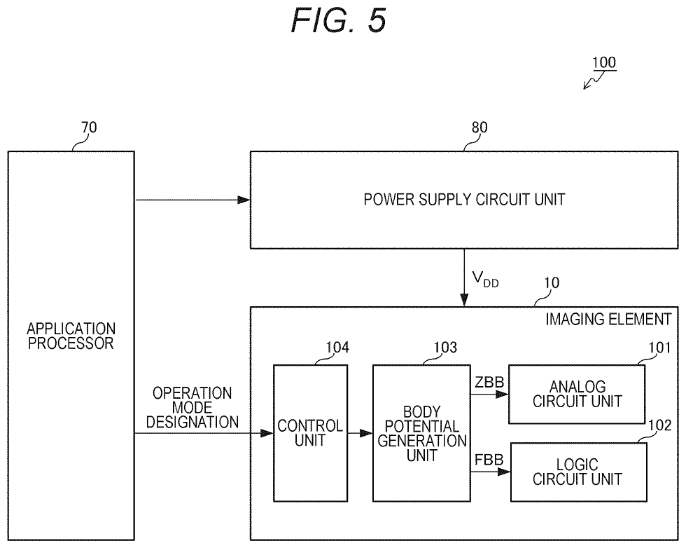

FIG. 5 is a block diagram illustrating an internal configuration example of the smartphone which is an example of the electronic device according to the present technology.

The smartphone 100 according to the present example includes the imaging element 10 of the present technology as an imaging unit, and includes an application processor 70 configured to designate an operation mode for the imaging element 10, and a power supply circuit unit 80 configured to supply the power supply voltage V_{DD} and the like to the imaging element 10 under control of the application processor 70. Note that the application processor 70 is an example of an operation mode designation unit described in the claims.

The imaging element 10 illustrated in FIG. 5 includes an analog circuit unit 101, a logic circuit unit 102, a body potential generation unit 103, and a control unit 104.

The analog circuit unit 101 includes the pixel array unit 11 in which the pixels 20 are two-dimensionally arranged in a matrix and the vertical scanning unit 12 in FIG. 1, the load MOS circuit 33 in FIG. 2, the comparator 52 in FIG. 3, and the like. The logic circuit unit 102 includes the column counter 53, the horizontal scanning unit 14, the digital signal computation unit 15, and the like in FIG. 3, and processes a signal read out from the pixel 20. The logic circuit unit 102 is a digital circuit unit including the column counter 53, the horizontal scanning unit 14, the digital signal computation unit 15, and the like, but is described as the logic circuit unit 102 in the present specification.

The imaging element 10 mounted on the smartphone 100 is required to improve a yield and reduce power consumption. Therefore, the imaging element 10 includes the body potential generation unit 103 in order to improve the yield and reduce power consumption. The body potential generation unit 103 applies a forward body bias (FBB) potential to a transistor forming the logic circuit unit 102, that is, a body potential in a direction of lowering a threshold voltage Vth to a well doped to enclose a transistor structure of the CMOS. Hereinafter, applying the body potential to the well may be simply described as applying the body potential to the transistor.

When the FBB potential is applied to the transistor forming the logic circuit unit 102, the body potential generation unit 103 applies a zero body bias (ZBB) potential (that is, a zero potential) to a transistor forming the analog circuit unit 101. However, at this time, the body potential to be applied to the transistor forming the analog circuit unit 101 is not limited to the control of applying the zero potential (hereinafter, described as ZBB potential control), and the control of applying the FBB potential (hereinafter, described as FBB potential control) may be applied.

The control unit 104 controls the body potential applied by the body potential generation unit 103 to each of the analog circuit unit 101 and the logic circuit unit 102. Specifically, under the control of the control unit 104, the body potential generation unit 103 applies the ZBB potential or the FBB potential as the body potential to the transistor forming the analog circuit unit 101, and applies the FBB potential as the body potential to the transistor forming the logic circuit unit 102.

### 2-3. CMOS Transistor Having Fully-Depleted SOI Structure

In the imaging element 10 having the configuration described above, in order to implement the FBB potential control, it is preferable to use a CMOS transistor having a silicon on insulator (SOI) structure constituting a device on a silicon thin film on an insulating film, particularly a CMOS transistor having a fully-depleted SOI structure, as a transistor forming the analog circuit unit 101 and the logic circuit unit 102, rather than using a normal bulk CMOS transistor.

Here, in order to implement the FBB potential control, the CMOS transistor having the SOI structure which is preferably used as the transistors forming the analog circuit unit 101 and the logic circuit unit 102 will be described in comparison with the bulk CMOS transistor.

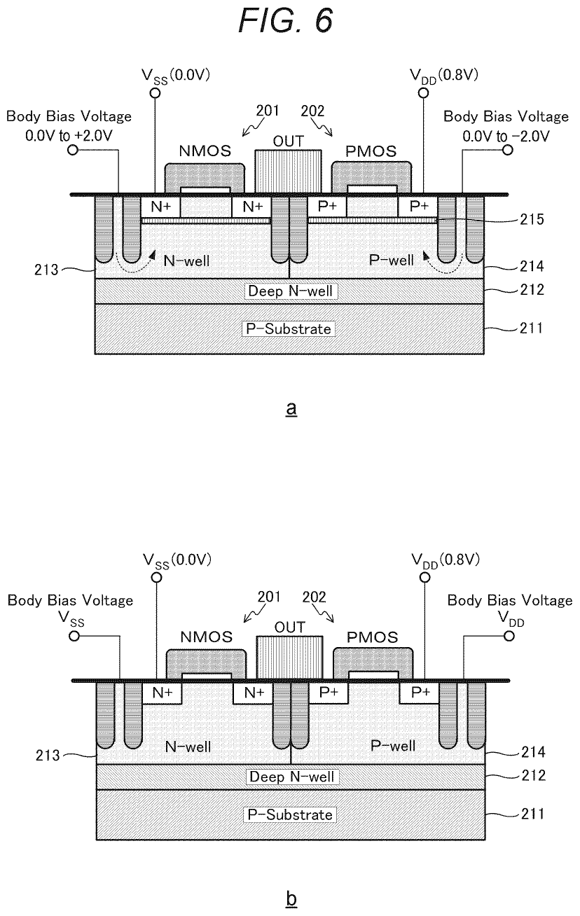

FIG. 6 is a cross-sectional view illustrating a cross-sectional structure of a CMOS transistor, for explaining the CMOS transistor having the fully-depleted SOI structure in comparison with the bulk CMOS transistor. In FIG. 6, “a” is a cross-sectional structure of the CMOS transistor having the fully-depleted SOI structure, and “b” in FIG. 6 is a cross-sectional structure of the bulk CMOS transistor.

Here, an N-type MOS transistor 201 and a P-type MOS transistor 202 connected in series to each other are illustrated for the CMOS transistor having the fully-depleted SOI structure and the bulk CMOS transistor. The N-type MOS transistor 201 and the P-type MOS transistor 202 are connected in series between a node of a low-potential-side power supply voltage V_{SS} (for example, 0.0 V) and the node of a high-potential-side power supply voltage V_{DD} (for example, 0.8 V).

As illustrated in “a” of FIG. 6 and “b” of FIG. 6, an N-type well 213 and a P-type well 214 are formed on a deep N-type well 212 on a P-type semiconductor substrate 211, and the N-type MOS transistor 201 and the P-type MOS transistor 202 are formed thereon. In the case of the CMOS transistor having the SOI structure, the N-type MOS transistor 201 and the P-type MOS transistor 202 are formed on a silicon on insulator (SOI) 215 formed on the N-type well 213 and the P-type well 214.

In the CMOS transistor having the SOI structure, the FBB potential, that is, a potential in a direction of lowering the threshold voltage Vth can be applied as the body potential, to the N-type well 213 and the P-type well 214 doped to enclose transistor structures of the N-type MOS transistor 201 and the P-type MOS transistor 202. More specifically, a potential of ±0.5 V or more (to ±2.0 V) can be applied as the body potential. By this FBB potential control, the threshold voltages Vth of the N-type MOS transistor 201 and the P-type MOS transistor 202 are lowered, so that performance can be improved.

The FBB potential, that is, the potential in the direction of lowering the threshold voltage Vth of the transistor is a positive potential (for example, 0.0 V to +2.0 V) in the case of the N-type MOS transistor 201 and a negative potential (for example, 0.0 V to −2.0 V) in the case of the P-type MOS transistor 202.

Also in the bulk CMOS transistor illustrated in “b” of FIG. 6, the FBB potential can be controlled in a case of a three-well structure. However, since a diode component is turned on in a forward direction, a potential that can be applied as the body potential is limited to ±0.5 V.

In addition, by using the CMOS transistor having the fully-depleted SOI structure as the transistors forming the analog circuit unit 101 and the logic circuit unit 102, and lowering the threshold voltage Vth with the FBB potential control to improve the performance, lower power consumption can be achieved. Specifically, by increasing a margin of a minimum operating power supply voltage Vmin by an amount of the performance earned by the FBB potential control, it is possible to reduce power consumption.

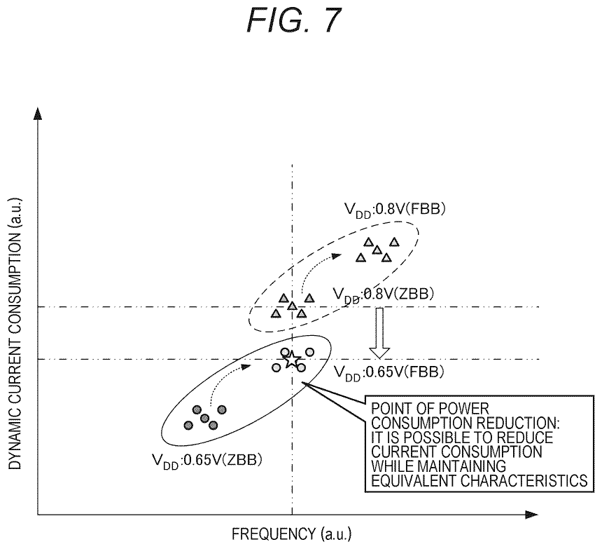

FIG. 7 illustrates a relationship between power consumption and performance. In the characteristic graph of FIG. 7, a horizontal axis represents a frequency, a vertical axis represents a dynamic current consumption, and the power consumption is smaller on the lower side in the vertical axis. As illustrated in the characteristic graph of FIG. 7, in a case where the power supply voltage V_{DD} is lowered from, for example, 0.8 V to, for example, 0.65 V, it is possible to reduce current consumption while maintaining equivalent characteristics by the FBB potential control, and thus, it is possible to achieve lower power consumption.

### 2-4. Operations and Effects of FBB Potential Control on Analog Circuit Unit

Here, operations and effects in a case where the FBB potential is applied to the transistor forming the analog circuit unit 101 will be described. Here, as the analog circuit unit 101, the vertical scanning unit 12 in FIG. 1, the load MOS circuit 33 in FIG. 2, and the comparator 52 constituting the input stage of the analog-digital conversion circuit 51 in FIG. 3 will be described.

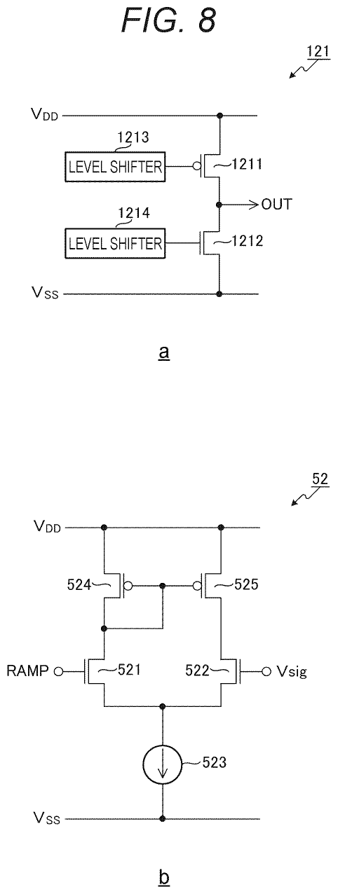

FIG. 8 is a circuit diagram illustrating a circuit example of the analog circuit unit 101. In FIG. 8, “a” is a circuit example of one transfer stage 121 of the vertical scanning unit 12 in FIG. 1, and “b” of FIG. 8 is a circuit example of the comparator 52 constituting an input stage of the analog-digital conversion circuit 51 in FIG. 3.

As illustrated in “a” of FIG. 8, one transfer stage 121 of the vertical scanning unit 12 includes a P-type MOS transistor 1211 and an N-type MOS transistor 1212 connected in series between the node of the high-potential-side power supply voltage V_{DD} and the node of the low-potential-side power supply voltage V_{SS}, and level shifters 1213 and 1214 connected to respective gates of the two transistors 1211 and 1212.

In one transfer stage 121 of the vertical scanning unit 12 having the above-described configuration, a transconductance gm of the P-type MOS transistor 1211 and the N-type MOS transistor 1212 can be increased by performing the FBB potential control on the P-type MOS transistor 1211 and the N-type MOS transistor 1212, so that a rise time and a fall time of an output pulse of the vertical scanning unit 12 can be improved. As a result, a charge transfer time of the pixel 20 becomes fast, and thus, it is possible to improve a frame rate (fps) or reduce power consumption by an amount earned by increasing the speed.

As illustrated in “b” of FIG. 8, the comparator 52 includes differential pair transistors 521 and 522 including an N-type MOS transistor, a constant current source 523, and a P-type MOS transistors 524 and 525 constituting a current mirror circuit. The reference signal RAMP of the ramp wave is input to a gate of one differential pair transistor 521, and the analog pixel signal Vsig is input to a gate of another differential pair transistor 522.

In the comparator 52 having the above-described configuration, by performing the FBB potential control on the differential pair transistors 521 and 522, a transconductance gm of the two transistors 521 and 522 can be increased, so that a bandwidth of the comparator 52 can be widened. As a result, since an operation of the comparator 52 becomes high speed, it is possible to improve a frame rate (fps) or reduce the power consumption by an amount earned by increasing the speed.

Note that, here, as a control target circuit of the analog circuit unit 101, one transfer stage 121 of the vertical scanning unit 12 and the comparator 52 constituting an input stage of the analog-digital conversion circuit 51 have been described. However, the load MOS circuit 33 in FIG. 2 may be the control target circuit.

In the load MOS circuit 33 in FIG. 2, by performing the FBB potential control on the MOS transistor constituting the constant current source 34, it is possible to suppress a variation in the threshold voltage Vth of the MOS transistor, and thus, it is possible to suppress a variation in the constant current source 34. Then, a size of the MOS transistor constituting the constant current source 34 can be reduced as much as the variation in the constant current source 34 can be suppressed, and leakage power can be reduced.

### 3. First Embodiment of Present Technology

A first embodiment of the present technology is an example in which a body potential is controlled for each operation mode of an imaging element.

### 3-1. Configuration Example of Imaging Element According to First Embodiment

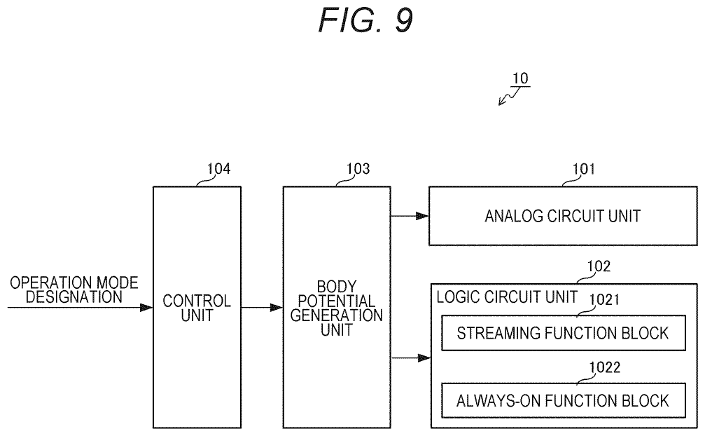

FIG. 9 is a block diagram illustrating a configuration example of an imaging element according to the first embodiment of the present technology.

As illustrated in FIG. 9, an imaging element 10 according to the first embodiment of the present technology has a configuration including an analog circuit unit 101, a logic circuit unit 102, a body potential generation unit 103, and a control unit 104. Each function of the analog circuit unit 101, the logic circuit unit 102, the body potential generation unit 103, and the control unit 104 is basically the same as the case of the imaging element 10 illustrated in FIG. 5.

In the imaging element 10 according to the first embodiment, a body potential to be applied to transistors forming the analog circuit unit 101 and the logic circuit unit 102 is controlled for each operation mode of the imaging element 10 designated from an outside. Examples of the operation mode of the imaging element 10 include a hardware-standby mode, a software-standby mode, an always-on mode, and a streaming mode.

These operation modes are well-known operation modes in an imaging element mounted on an electronic device such as a smartphone. Specifically, the hardware-standby mode is one of power saving functions, and is a mode of bringing all modules other than an internal random access memory (RAM) into a reset state. The software-standby mode is one of power saving functions, and is a mode for stopping a central processing unit (CPU), an oscillator, and the like. The always-on mode is a mode of partially supplying power even when a device main body is in a resting state, and only a specific function is always in an operating state. The streaming mode is a mode of performing still image capturing and moving image capturing.

### 3-2. Body Potential Control for Each Operation Mode

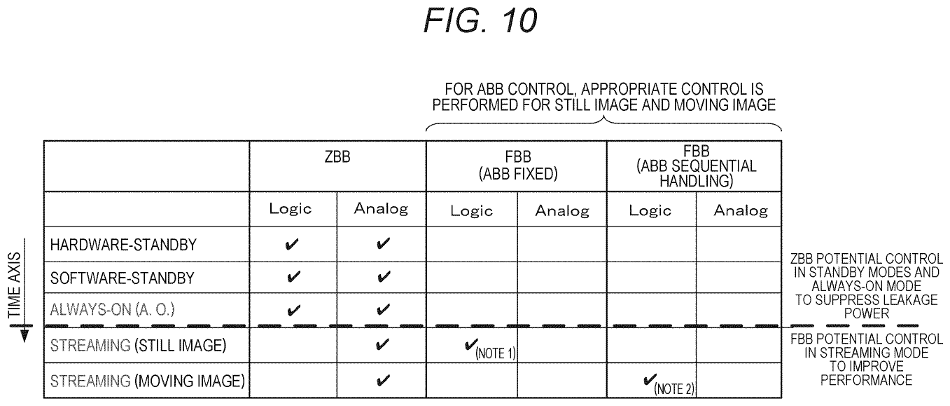

FIG. 10 is a table for explaining body potential control for each operation mode in the imaging element 10 according to the first embodiment of the present technology.

In the imaging element 10 according to the first embodiment, the control unit 104 controls a body potential at a time of FBB potential control for each operation mode of the imaging element 10 designated from an outside, specifically, for each operation mode of the imaging element 10 designated by an external application processor 70.

The control unit 104 controls the body potential to be applied to the transistors forming the analog circuit unit 101 and the logic circuit unit 102 for each of the hardware-standby mode, the software-standby mode, the always-on mode, and the streaming mode.

Specifically, in the hardware-standby mode, the software-standby mode, and the always-on mode, the control unit 104 performs ZBB potential control on the body potential to be applied to the transistors forming the analog circuit unit 101 and the logic circuit unit 102. Since leakage power can be suppressed by the ZBB potential control, lower power consumption can be achieved.

Furthermore, in the streaming mode, the control unit 104 performs the FBB potential control on the body potential to be applied to the transistor forming the logic circuit unit 102. The performance can be improved by this FBB potential control. At this time, the body potential to be applied to the transistor forming the analog circuit unit 101 is subjected to ZBB potential control. The streaming mode includes a still image capturing mode and a moving image capturing mode.

When the operation mode is the streaming mode, the control unit 104 controls the body potential in accordance with each of the still image capturing mode and the moving image capturing mode. Specifically, in the FBB potential control in the streaming mode, the control unit 104 fixes an adaptive body bias (ABB) potential in the still image capturing mode (note 1 in FIG. 10). As a result, gradation at some midpoint in a still image can be avoided. Furthermore, in the FBB potential control in the streaming mode, the control unit 104 sequentially handles the ABB potential in the moving image capturing mode (note 2 in FIG. 10). As a result, it is possible to sequentially cope with a temperature fluctuation during 8K moving image capturing.

### 3-3. Transition of Operation Mode

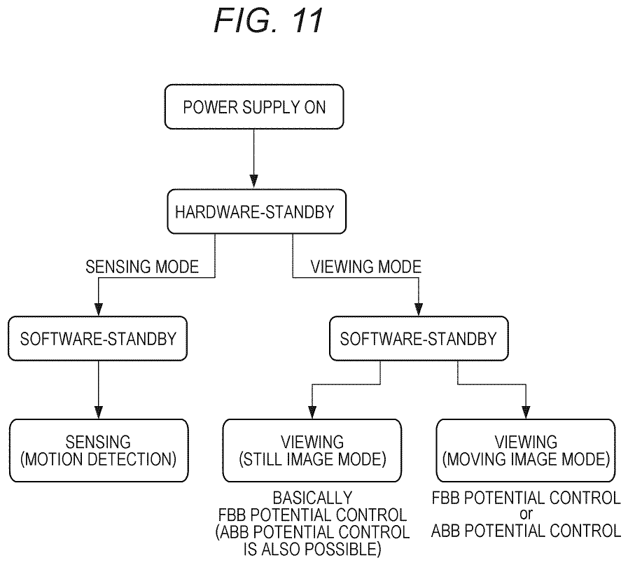

FIG. 11 is a state transition diagram illustrating state transition of the operation mode in the imaging element according to the first embodiment of the present technology.

When a power-off state is switched to a power-on state, the state transitions to the hardware-standby mode. In a case where a sensing mode is selected in the state of the hardware-standby mode, the state transitions to the sensing (motion detection) mode through the software-standby mode. Furthermore, in a case where a viewing mode is selected in the hardware-standby mode, the state transitions to the still image capturing mode or the moving image capturing mode through the software-standby mode.

The control unit 104 performs the FBB potential control in accordance with the above-described state transition of the operation mode. In the still image capturing mode, basically, the FBB potential control is performed, but adaptive control (hereinafter, described as ABB potential control) for applying the ABB potential can also be performed. In the moving image capturing mode, the FBB potential control or the ABB potential control is performed.

As illustrated in FIG. 9, the imaging element 10 according to the first embodiment of the present technology has a configuration in which the logic circuit unit 102 is divided into a streaming function block 1021 that executes a streaming function and an always-on function block 1022 that executes an always-on function. This block division can be achieved by separating wells.

For the logic circuit unit 102 divided into the streaming function block 1021 and the always-on function block 1022, the control unit 104 applies, as a body potential to be applied to the transistor forming the logic circuit unit 102, a high potential of 0 V or more to the N-type well and a low potential of 0 V or less to the P-type well in the streaming function block 1021, as compared with the always-on function block 1022.

In this manner, the logic circuit unit 102 is divided into the streaming function block 1021 and the always-on function block 1022, and a high potential of 0 V or more is applied to the N-type well and a low potential of 0 V or less is applied to the P-type well in the streaming function block 1021, as compared with the always-on function block 1022. As a result, a threshold voltage can be lowered to increase the performance of the streaming function block 1021.

### 4. Second Embodiment of Present Technology

A second embodiment of the present technology is an example in which a body potential is controlled by following a characteristic fluctuation factor of an imaging element.

### 4-1. Configuration Example of Imaging Element According to Second Embodiment

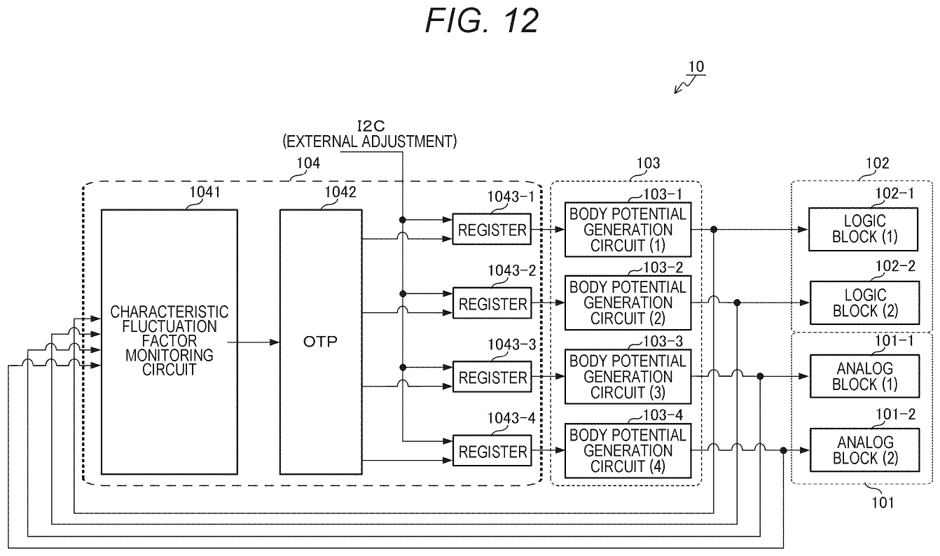

FIG. 12 is a block diagram illustrating a configuration example of the imaging element according to the second embodiment of the present technology.

Here, as an example, two divided analog blocks (1) 101-1 and (2) 101-2 are illustrated as an analog circuit unit 101 which is a control target circuit, and two divided logic blocks (1) 102-1 and (2) 102-2 are illustrated as a logic circuit unit 102 which is a control target circuit. The division of the analog block (1) 101-1 and the analog block (2) 101-2 and the division of the logic block (1) 102-1 and the logic block (2) 102-2 can be achieved by separating wells.

A body potential is applied to the two logic blocks (1) 102-1 and (2) 102-2 in the logic circuit unit 102 from a body potential generation circuit (1) 103-1 and a body potential generation circuit (2) 103-2 in a body potential generation unit 103. In addition, a body potential is applied to the two analog blocks (1) 101-1 and (2) 101-2 in the analog circuit unit 101 from a body potential generation circuit (3) 103-3 and a body potential generation circuit (4) 103-4 in the body potential generation unit 103.

A control unit 104 is for controlling the body potential to be applied to each of the analog circuit unit 101 and the logic circuit unit 102, and includes a characteristic fluctuation factor monitoring circuit 1041, an OTP (one time memory) 1042 which is an example of a semiconductor switch IC, and four registers 1043-1 to 1043-4.

### 4-2. Arrangement Image of Individual Circuit Units Constituting Imaging Element According to Second Embodiment

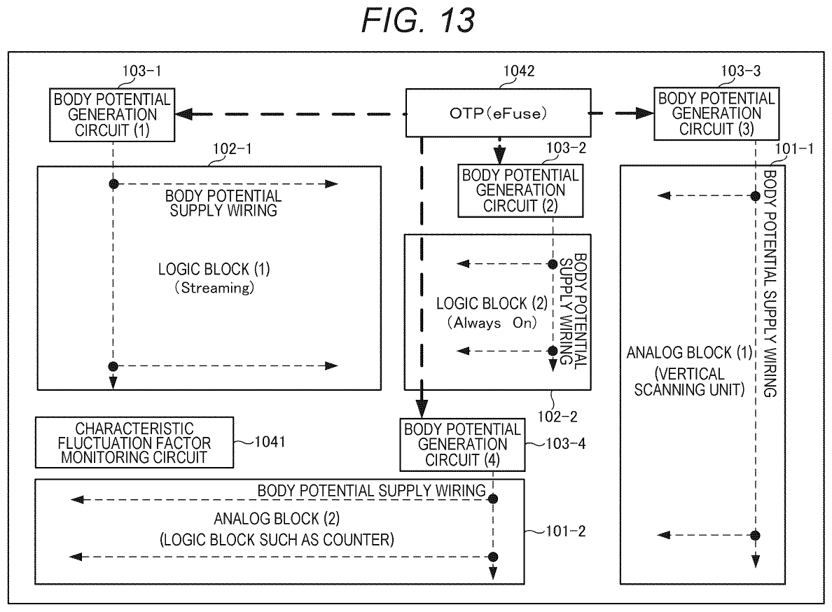

FIG. 13 illustrates an example of an arrangement image of the analog circuit unit 101, the logic circuit unit 102, the body potential generation unit 103, the characteristic fluctuation factor monitoring circuit 1041, and the OTP 1042. Note that, in FIG. 13, illustration of the four registers 1043-1 to 1043-4 in FIG. 12 is omitted.

In the control unit 104, the characteristic fluctuation factor monitoring circuit 1041 monitors a characteristic fluctuation factor of an imaging element 10, specifically, a variation in the characteristic fluctuation factor. Examples of the variation in the characteristic fluctuation factor include a variation in a process (P), a variation in a junction temperature (T), and a variation in a power supply voltage (V).

The characteristic fluctuation factor monitoring circuit 1041 supplies a monitoring result of the variation of the characteristic fluctuation factor to the body potential generation unit 103 via the OTP 1042 and the four registers 1043-1 to 1043-4. The body potential generation unit 103 controls the body potential to be applied to transistors forming the analog circuit unit 101 and the logic circuit unit 102, in accordance with the monitoring result of the variation in the characteristic fluctuation factor obtained by the characteristic fluctuation factor monitoring circuit 1041.

### 4-3. Example of Controlling Body Potential by Following PVT Variation

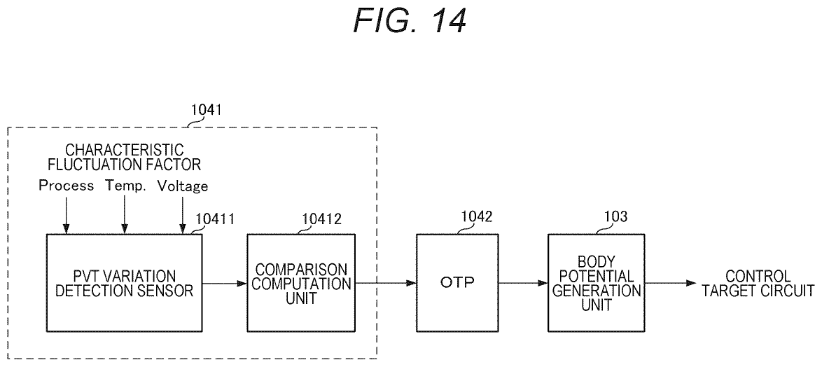

FIG. 14 is a block diagram illustrating a configuration example of the characteristic fluctuation factor monitoring circuit 1041 in the imaging element according to the second embodiment.

As illustrated in FIG. 14, the characteristic fluctuation factor monitoring circuit 1041 includes a PVT variation detection sensor 10411 and a comparison computation unit 10412.

The PVT variation detection sensor 10411 monitors at least one of a variation in the process (P), a variation in the junction temperature (T), and a variation in the power supply voltage (V). The variation in the process can be detected as a “resulting state of the process” such as SS (PMOS: Slow, NMOS: Slow), TT (PMOS: Typical, NMOS: Typical), and FF (PMOS: Fast, NMOS: Fast). Here, “Slow” indicates a high threshold voltage, “Fast” indicates a low threshold voltage, and “Typical” indicates an intermediate value.

The PVT variation detection sensor 10411 can be configured by, for example, an oscillator using a phase locked loop (PLL) circuit, and the like. The comparison computation unit 10412 calculates a control value to be used for control of the body potential generation unit 103, on the basis of a detection result of a PVT variation obtained by the PVT variation detection sensor 10411. The comparison computation unit 10412 may be configured to use a table in which the detection result of the PVT variation obtained by the PVT variation detection sensor 10411 and the control value to be used for control of the body potential generation unit 103 are stored in a correspondence relationship.

As described above, by adaptively controlling an output potential of the body potential generation unit 103, that is, a body potential to be applied to the transistors forming the analog circuit unit 101 and the logic circuit unit 102 by following the PVT variation, it is possible to absorb variations in the entire imaging element.

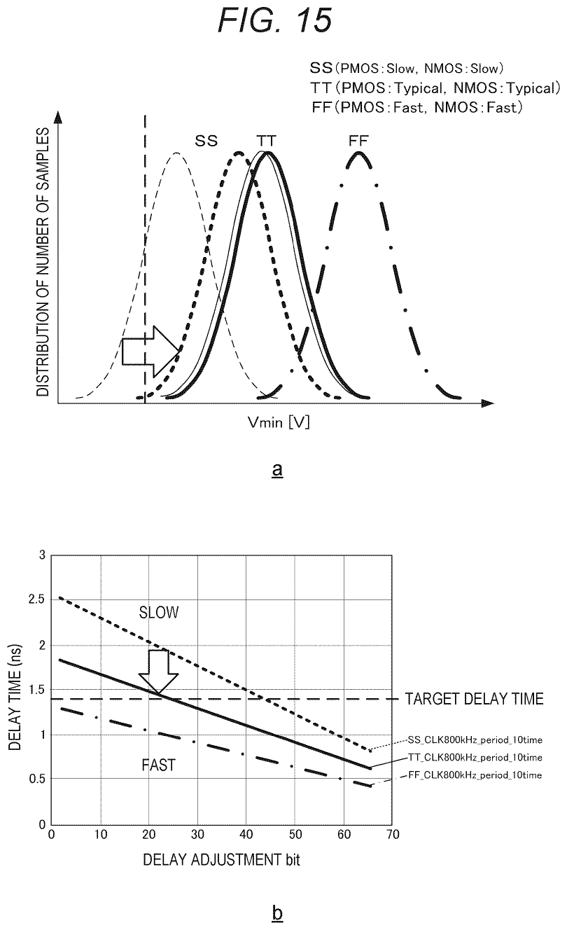

Here, an image of the PVT variation detection sensor 10411 in a case of monitoring a resulting state of the process (P) will be described with reference to FIG. 15.

In FIG. 15, “a” is a graph for explaining resulting states of the process such as SS, TT, and FF. A solid line in the figure represents TT (PMOS: Typical, NMOS: Typical). A broken line in the figure indicates SS (PMOS: Slow, NMOS: Slow), that is, indicates that the resulting state of the process is poor (slow). A dashed-dotted line in the figure indicates FF (PMOS: Fast, NMOS: Fast), that is, good (fast) as the resulting state of the process.

At a product inspection stage, a product whose resulting state of the process is SS is detected. Then, by the FBB potential control, control is performed in which a predetermined body potential is applied from the body potential generation unit 103 to the transistors forming the analog circuit unit 101 and the logic circuit unit 102, to shift the resulting state of the process to the TT side. For products whose resulting state of the process is TT or FF, the FBB potential control is unnecessary because there is a margin.

In FIG. 15, “b” illustrates an image of body potential adjustment by the body potential generation unit 103. In the figure, resulting states (variations) of the process can be grasped from a gradient of a voltage-frequency characteristic indicated by an inclined straight line (SS: dotted line, TT: solid line, FF: dashed-dotted line). Then, in a case where the resulting state of the process is SS, the FBB potential control is executed.

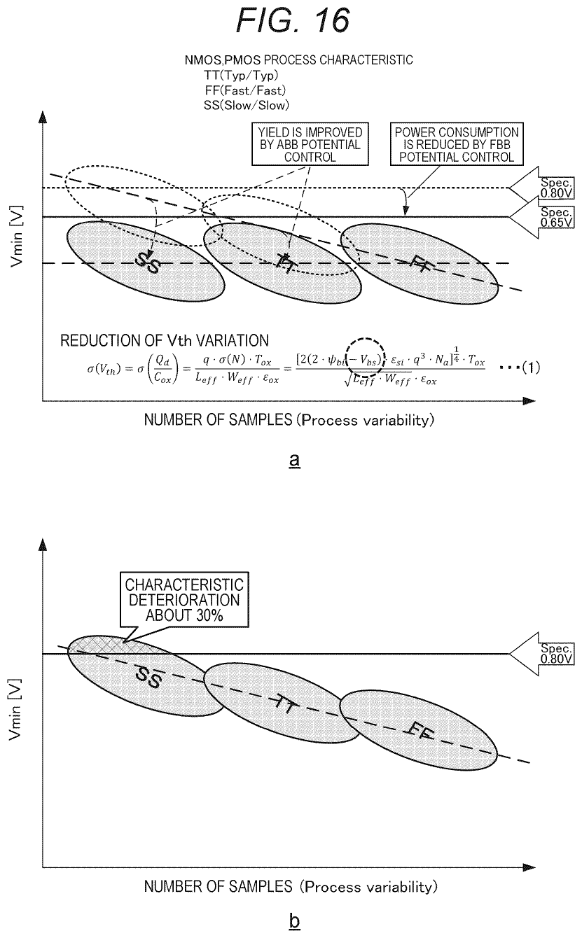

Next, a relationship between a minimum operating power supply voltage Vmin and a variation in the process will be described with reference to FIG. 16.

FIG. 16 is a graph for explaining a relationship between the minimum operating power supply voltage Vmin and a variation in the process. In FIG. 16, “a” illustrates a characteristic of the minimum operating power supply voltage Vmin under the ABB potential control, and “b” of FIG. 16 illustrates a characteristic of the minimum operating power supply voltage Vmin under the ZBB potential control.

As illustrated in “a” of FIG. 16, lower power consumption can be achieved by the FBB potential control, and a yield can be improved by the ABB potential control (adaptive control). As described above, the power consumption reduction by the FBB potential control and the yield improvement by the ABB potential control can be simultaneously achieved by using the CMOS transistor having the fully-depleted SOI structure as the transistors forming the analog circuit unit 101 and the logic circuit unit 102. In other words, by using the CMOS transistor having the fully-depleted SOI structure as the transistors forming the analog circuit unit 101 and the logic circuit unit 102, it is possible to simultaneously achieve the lower power consumption by the FBB potential control and the yield improvement by the ABB potential control.

Incidentally, as illustrated in “b” of FIG. 16, in the case of the control of applying the ZBB potential, characteristic deterioration of about 30% occurs. That is, the variation in the process is large, and SS (PMOS: Slow, NMOS: Slow) in the logic circuit unit 102 is one of the factors that lower the yield. In order not to lower the yield, it is necessary to increase power and an area.

### 4-4. Example of Controlling Body Potential in Accordance With Variation in Saturation Electron Count and Conversion Efficiency

In the example described above, the body potential is controlled by following variations in the process (P), the junction temperature (T), and the power supply voltage (V). Whereas, in the present example, the body potential is controlled in accordance with variations in a saturation electron count Qs of a pixel and a conversion efficiency η (uV/e−) of the pixel.

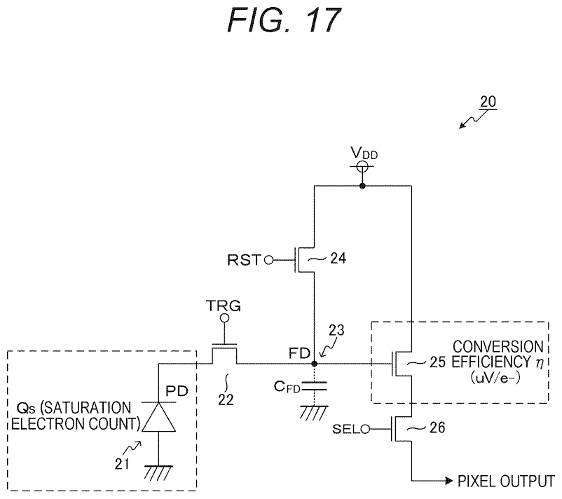

FIG. 17 is a circuit diagram for explaining the saturation electron count Qs of the pixel and the conversion efficiency η of the pixel. Here, the saturation electron count Qs of the pixel is a saturation electron count of a photoelectric conversion unit 21, for example, a photodiode of PN junction. The conversion efficiency η of the pixel is a charge-voltage conversion efficiency (uV/e−) of a signal amplification unit 25. The variations (resulting states) in the saturation electron count Qs and the conversion efficiency η can be grasped using a known mass production tester.

In the characteristic fluctuation factor monitoring circuit 1041 (see FIG. 14) in the imaging element according to the second embodiment, by replacing the PVT variation detection sensor 10411 with the above-described mass production tester, the body potential can be controlled by the FBB potential control in accordance with resulting states (variations) of the saturation electron count Qs and the conversion efficiency η. The FBB potential control here is potential fixed FBB or ABB potential control.

As described above, by adaptively controlling the body potential to be applied to the transistors forming the analog circuit unit 101 and the logic circuit unit 102 in accordance with the resulting states (variations) of the saturation electron count Qs of the pixel and the conversion efficiency η of the pixel, it is possible to absorb variations in the entire imaging element.

Note that, here, the FBB potential control is performed in accordance with the resulting states of both the saturation electron count Qs of the pixel and the conversion efficiency η of the pixel. However, the FBB potential control may be performed in accordance with the resulting state of one of the saturation electron count Qs of the pixel and the conversion efficiency η of the pixel.

### 5. Modification

Note that the embodiments described above show examples for embodying the present technology, and the respective matters in the embodiments and the respective matters specifying the invention in the claims have correspondence relationships. Similarly, the matters specifying the invention in the claims and the matters with the same names in the embodiments of the present technology have correspondence relationships. However, the present technology is not limited to the embodiments, and can be embodied by applying various modifications to the embodiments without departing from the scope of the present technology.

### 6. Configuration That Can be Adopted by Present Technology

Note that the present technology may also have the following configuration.
(1) An imaging element including:
   an analog circuit unit including a pixel that performs photoelectric conversion;
   a logic circuit unit configured to process a signal read out from the pixel;
   a body potential generation unit configured to apply a body potential in a direction of lowering a threshold voltage to a well doped to enclose a transistor structure in a transistor forming the logic circuit unit; and
   a control unit configured to control the body potential for each operation mode designated from an outside.
(2) The imaging element according to (1) above, in which
   when the operation mode is a streaming operation mode, the control unit controls the body potential in accordance with each of a still image capturing mode and a moving image capturing mode.
(3) The imaging element according to (2) above, in which
   the logic circuit unit is divided into a streaming function block and an always-on function block, and
   the control unit applies, as the body potential, a high potential higher than or equal to 0 V to an N-type well and a low potential lower than or equal to 0 V to a P-type well in the streaming function block, as compared with the always-on function block.
(4) The imaging element according to (1) above, in which
   the body potential generation unit applies a zero potential to a well doped to enclose a transistor structure in a transistor forming the analog circuit unit.
(5) The imaging element according to (1) above, in which
   the body potential generation unit applies a body potential in a direction of lowering a threshold voltage to a well doped to enclose a transistor structure in a transistor forming the analog circuit unit.
(6) The imaging element according to any one of (1) to (5) above, in which
   each of a transistor forming the logic circuit unit and a transistor forming the analog circuit unit is a MOS transistor having a fully depleted silicon-on-insulator structure.
(7) An imaging element including:
   an analog circuit unit including a pixel that performs photoelectric conversion;
   a logic circuit unit configured to process a signal read out from the pixel; and
   a body potential generation unit configured to apply a body potential in a direction of lowering a threshold voltage to a well doped to enclose a transistor structure in a transistor forming the logic circuit unit.
(8) The imaging element according to (7) above, in which
   the body potential generation unit controls the body potential by following a characteristic fluctuation factor of the imaging element.
(9) The imaging element according to (8) above, in which
   the characteristic fluctuation factor is at least one of a variation in a process, a variation in a junction temperature, or a variation in a power supply voltage.
(10) The imaging element according to (7) above, in which
   the body potential generation unit controls the body potential in accordance with at least one of a resulting state of a saturation electron count of the pixel or a resulting state of conversion efficiency of the pixel.
(11) The imaging element according to (7) above, in which
   the body potential generation unit applies a zero potential to a well doped to enclose a transistor structure in a transistor forming the analog circuit unit.
(12) The imaging element according to (7) above, in which
   the body potential generation unit applies a body potential in a direction of lowering a threshold voltage to a well doped to enclose a transistor structure in a transistor forming the analog circuit unit.
(13) The imaging element according to any one of (7) to (12) above, in which
   each of a transistor forming the logic circuit unit and a transistor forming the analog circuit unit is a MOS transistor having a fully depleted silicon-on-insulator structure.
(14) An electronic device including:
   an imaging element; and
   an operation mode designation unit configured to designate an operation mode for the imaging element, in which
   the imaging element includes:
      an analog circuit unit including a pixel that performs photoelectric conversion;
      a logic circuit unit configured to process a signal read out from the pixel;
      a body potential generation unit configured to apply a body potential in a direction of lowering a threshold voltage to a well doped to enclose a transistor structure in a transistor forming the logic circuit unit; and
   a control unit configured to control the body potential for each operation mode designated by the operation mode designation unit.

### Reference Signs List

10 Imaging element
11 Pixel array unit
12 Vertical scanning unit
13 Column processing unit
14 Horizontal scanning unit
15 Digital signal computation unit
16 Timing control unit
20 Pixel (pixel circuit)
21 Photoelectric conversion unit
22 Charge transfer unit
23 Charge-voltage conversion unit
24 Charge resetting unit
25 Signal amplification unit
26 Pixel selection unit
31 Pixel control line
32 Signal line
33 Load MOS circuit
34 Constant current source
50 Analog-digital conversion unit
51 Analog-digital conversion circuit
52 Comparator
53 Column counter
60 Reference signal generation unit
70 Application processor
80 Power supply circuit unit
101 Analog circuit unit
102 Logic circuit unit
103 Body potential generation unit
104 Control unit
1041 Characteristic fluctuation factor monitoring circuit
1042 OTP (one time memory)
1043-1 to 1043-4 Register

What is claimed is:

1. An imaging element, comprising:
an analog circuit unit including a pixel that performs photoelectric conversion;
a logic circuit unit configured to process a signal read out from the pixel;
a body potential generation unit configured to apply a body potential in a direction of lowering a threshold voltage to a well doped to enclose a transistor structure in a transistor forming the logic circuit unit; and
a control unit configured to control the body potential for each operation mode designated from an outside.

2. The imaging element according to claim 1, wherein
when the operation mode is a streaming operation mode, the control unit controls the body potential in accordance with each of a still image capturing mode and a moving image capturing mode.

3. The imaging element according to claim 2, wherein
the logic circuit unit is divided into a streaming function block and an always-on function block, and
the control unit applies, as the body potential, a high potential higher than or equal to 0 V to an N-type well and a low potential lower than or equal to 0 V to a P-type well in the streaming function block, as compared with the always-on function block.

4. The imaging element according to claim 1, wherein
the body potential generation unit applies a zero potential to a well doped to enclose a transistor structure in a transistor forming the analog circuit unit.

5. The imaging element according to claim 1, wherein
the body potential generation unit applies a body potential in a direction of lowering a threshold voltage to a well doped to enclose a transistor structure in a transistor forming the analog circuit unit.

6. The imaging element according to claim 1, wherein
each of a transistor forming the logic circuit unit and a transistor forming the analog circuit unit is a metal oxide semiconductor (MOS) transistor having a fully depleted silicon-on-insulator structure.

7. An imaging element, comprising:
an analog circuit unit including a pixel that performs photoelectric conversion;
a logic circuit unit configured to process a signal read out from the pixel; and
a body potential generation unit configured to apply a body potential in a direction of lowering a threshold voltage to a well doped to enclose a transistor structure in a transistor forming the logic circuit unit.

8. The imaging element according to claim 7, wherein
the body potential generation unit controls the body potential by following a characteristic fluctuation factor of the imaging element.

9. The imaging element according to claim 8, wherein
the characteristic fluctuation factor is at least one of a variation in a process, a variation in a junction temperature, or a variation in a power supply voltage.

10. The imaging element according to claim 7, wherein
the body potential generation unit controls the body potential in accordance with at least one of a resulting state of a saturation electron count of the pixel or a resulting state of conversion efficiency of the pixel.

11. The imaging element according to claim 7, wherein
the body potential generation unit applies a zero potential to a well doped to enclose a transistor structure in a transistor forming the analog circuit unit.

12. The imaging element according to claim 7, wherein
the body potential generation unit applies a body potential in a direction of lowering a threshold voltage to a well doped to enclose a transistor structure in a transistor forming the analog circuit unit.

13. The imaging element according to claim 7, wherein
each of a transistor forming the logic circuit unit and a transistor forming the analog circuit unit is a MOS transistor having a fully depleted silicon-on-insulator structure.

14. An electronic device, comprising:
an imaging element; and
an operation mode designation unit configured to designate an operation mode for the imaging element, wherein
the imaging element includes:
an analog circuit unit including a pixel that performs photoelectric conversion;
a logic circuit unit configured to process a signal read out from the pixel;
a body potential generation unit configured to apply a body potential in a direction of lowering a threshold voltage to a well doped to enclose a transistor structure in a transistor forming the logic circuit unit; and
a control unit configured to control the body potential for each operation mode designated by the operation mode designation unit.
